(19) United States
(12) Patent Application Publication
(10) Pub. No.: US 2023/0040248 A1
(43) Pub. Date: Feb. 9, 2023

(54) BATTERY MODULE

(71) Applicant: SAMSUNG SDI CO., LTD., Yongin-si (KR)

(72) Inventor: Jong-Chan HAN, Yongin-si (KR)

(21) Appl. No.: 17/872,317

(22) Filed: Jul. 25, 2022

(30) Foreign Application Priority Data
Jul. 26, 2021 (KR) 10-2021-0098040

(51) Int. Cl. H01M 50/298; H01M 50/296

(52) U.S. Cl. CPC H01M 50/298; H01M 50/296; H01M 2220/20

(57) ABSTRACT

A battery module includes: a battery cell stack including a plurality of battery cells; a first connection member coupled to anode terminals of the plurality of battery cells; and a second connection member coupled to cathode terminals of the plurality of battery cells. The first connection member includes a first common node to which a first module terminal is coupled. The second connection member includes a second common node to which a second module terminal is coupled. The first common node is located between a center of the battery cell stack and a first battery cell, among first and second battery cells located at outermost sides of the battery cell stack. The second common node is located between the second battery cell and the center of the battery cell stack.

### CROSS-REFERENCE TO RELATED APPLICATION

This application claims priority to and the benefit of Korean Patent Application No. 10-2021-0098040 filed in the Korean Intellectual Property Office on Jul. 26, 2021, the entire contents of which are incorporated herein by reference.

### BACKGROUND

### 1. Field

Embodiments relate to a battery module.

### 2. Description of the Related Art

A secondary battery may be repeatedly charged and discharged, and thus the secondary battery is different from a primary battery which just non-reversibly converts a chemical material into electrical energy. A secondary battery with a relatively low capacity may be used for a power device of a small electronic device such as a portable phone, a laptop computer, or a camcorder, and a secondary battery with a relatively high capacity may be used for a power device of an electric vehicle.

It is desirable for an electric vehicle to use a battery with a high capacity to increase a driving distance. Accordingly, a battery module, configured by connecting a plurality of battery cells in series or in parallel, may be used for an electric vehicle. Particularly, in order to configure a battery module with a high capacity, a plurality of battery cells may be coupled in parallel.

The above information disclosed in this Background section is only for enhancement of understanding of the background of the invention, and therefore it may contain information that does not form the prior art that is already known in this country to a person of ordinary skill in the art.

### SUMMARY

According to an embodiment, a battery module includes: first and second module terminals connected to an external device of a battery module; a battery cell stack including a plurality of battery cells; a first connection member coupled to anode terminals of the plurality of battery cells; and a second connection member coupled to cathode terminals of the plurality of battery cells. The first connection member may include a first common node to which the first module terminal is coupled and the second connection member includes a second common node to which the second module terminal is coupled. The first common node may be located between a center of the battery cell stack and a first battery cell of first and second battery cells located at an outermost side of the battery cell stack in the first connection member. The second common node may be located between the second battery cell and the center of the battery cell stack in the second connection member.

The first common node and the second common node may be located symmetric to each other based on the center of the battery cell stack.

The first common node may be located closest to a third battery cell located at an n/4-th position in an array order of a first direction among the plurality of battery cells and the second common node may be located closest to a fourth battery cell located at an n/4-th position in the array order of a second direction which is opposite to the first direction among the plurality of battery cells. Here, the n represents the total number of the plurality of battery cells.

The first common node may be located closest to a fifth battery cell located at an a-th position in the array order of a first direction among the plurality of battery cells, and the second common node may be located closest to a sixth battery cell located at a b-th position in the array order of the second direction which is opposite to the first direction among the plurality of battery cells. Here, the a and the b are integers closest to n/4, and the n represents the total number of the plurality of battery cells.

The first common node may be located between seventh and eighth battery cells located at c and d-th positions in the array order of the first direction among the plurality of battery cells, and the second common node may be located between ninth and tenth battery cells located at e and f-th positions in the array order of the second direction which is opposite to the first direction among the plurality of battery cells. Here, the c and the e are one of two integers closest n/4, the d and the f are the other one of two integers, and the n represents the total number of the plurality of battery cells.

At least one battery cell may be located between the first battery cell and the first common node and between the second battery cell and the second common node.

The number of battery cells located between the first battery cell and the first common node and the number of battery cells located between the second battery cell and the second common node may be the same as each other.

The battery module may further include: a first common terminal for coupling the first connection member to the first module terminal; and a second common terminal for coupling the second connection member to the second module terminal.

According to an embodiment, a battery module includes: first and second module terminals connected to an external device of a battery module; and a plurality of battery sub-modules. Each of the plurality of battery sub-modules may include a battery cell stack including a plurality of battery cells, a first connection member coupled to anode terminals of the plurality of battery cells, and a second connection member coupled to cathode terminals of the plurality of battery cells. The first connection member of a first battery sub-module having a highest potential among the plurality of battery sub-modules may include a first common node to which the first module terminal is coupled, and the second connection member of a second battery sub-module having a lowest potential among the plurality of battery sub-modules may include a second common node to which the second module terminal is coupled. The first common node may be located between a first battery cell of two battery cells located at an outermost side of the first battery sub-module and a center of the battery module in the first connection member of the first battery sub-module. The second common node may be located between a second battery cell located in an opposite direction to the first battery cell of two battery cells located at an outermost side of the second battery sub-module and the center of the battery module in the second connection member of the second battery sub-module.

The first common node and the second common node may be located symmetric to each other based on the center of the battery module.

The first common node may be located closest to a third battery cell located at an n/4-th position in an array order of a first direction among the plurality of battery cells of the first battery sub-module.

The second common node may be located closest to a fourth battery cell located at an n/4-th position in the array order of a second direction which is opposite to the first direction among the plurality of battery cells of the second battery sub-module. Here, the n represents the total number of the plurality of battery cells.

The first common node may be located closest to a fifth battery cell located at an a-th position in an array order of a first direction among the plurality of battery cells of the first battery sub-module, and the second common node may be located closest to a sixth battery cell located at a b-th position in the array order of a second direction which is opposite to the first direction among the plurality of battery cells of the second battery sub-module. Here, the a and the b are integers closest to n/4, and the n represents the total number of the plurality of battery cells.

The first common node may be located between seventh and eighth battery cells located at c and d-th positions in the array order of the first direction among the plurality of battery cells of the first battery sub-module, and the second common node may be located between ninth and tenth battery cells located at e and f-th positions in the array order of the second direction which is opposite to the first direction among the plurality of battery cells of the second battery sub-module. Here, the c and the e are one of two integers closest n/4, the d and the f are the other one of two integers, and the n represents the total number of the plurality of battery cells.

At least one battery cell may be located between the first battery cell and the first common node and between the second battery cell and the second common node.

The number of battery cells located between the first battery cell and the first common node and the number of battery cells located between the second battery cell and the second common node may be the same as each other.

The battery module may further include: a first common terminal for coupling the first connection member of the first battery sub-module to the first module terminal; and a second common terminal for coupling the second connection member of the second battery sub-module to the second module terminal.

### BRIEF DESCRIPTION OF THE DRAWINGS

Features will become apparent to those of skill in the art by describing in detail example embodiments with reference to the attached drawings in which:

FIG. 1A schematically illustrates a battery module according to an example embodiment.

FIG. 1B is a schematic equivalent circuit of the battery module according to an example embodiment.

FIG. 2A schematically illustrates a battery module according to another example embodiment.

FIG. 2B is a schematic equivalent circuit of the battery module according to another example embodiment.

FIG. 3 schematically illustrates a battery module according to yet another example embodiment.

FIGS. 4A and 4B illustrate an example of a comparative battery module.

FIG. 5 is a diagram for describing effects of an example embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. Like reference numerals refer to like elements throughout.

In the present specification, the term “and/or” refers to all combinations or an arbitrary combination of a plurality of related listed items. When the example embodiments are described using “can” or “may”, it refers to at least one example embodiment of “the present invention. In the following description of an example embodiment, terms in the singular form may include the plural form unless the context states otherwise.

In this specification, terms including ordinal numbers such as “first,” “second,” or “third” are used to explain various components, but the components are not limited by these terms. These terms are used only to distinguish one component from the other component. For example, without departing the scope, the second component may be referred to as a first component and likewise, the first component may be referred to as the second component.

Further, a size and a thickness of each composition illustrated in the drawing are arbitrarily illustrated for the convenience of description so that the example embodiments are not necessarily limited those illustrated in the drawing. In the drawings, in order to clearly express various layers and regions, a thickness and the area may be exaggerated.

In the present specification, when it is described that one component or layer is “connected” or “coupled” “on” the other component or layer, it means that one component may be formed on the other component directly or with one or more other components or layers interposed therebetween. Further, when it is described that one component or layer is placed “between” two components or layers, it should be understood that one component or layer is the only one component or layer between two components or layers or there may be one or more interposed elements or layers. Further, when two components are electrically connected, it means that two components are directly connected or connected with the other component therebetween. The other component may include a switch, a resistor, and a capacitor. In the description of the example embodiments, “connect” means “electrically connect” when there is no expression of direct connection.

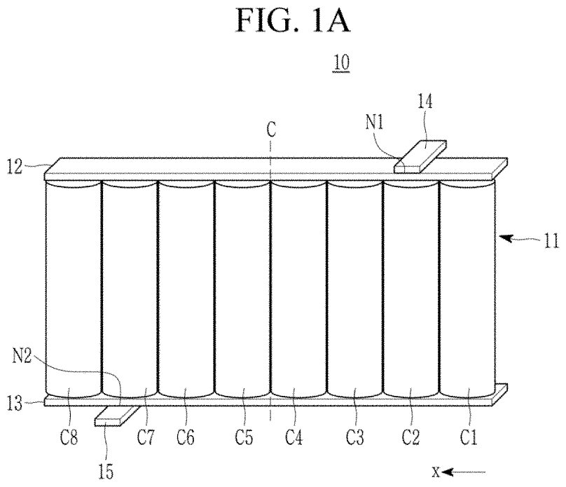

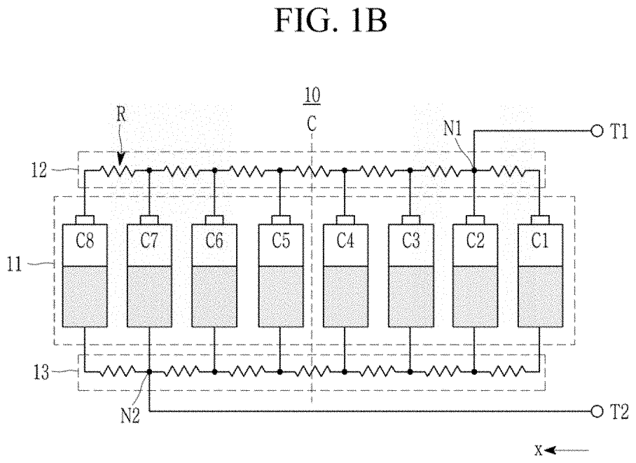

FIG. 1A schematically illustrates a battery module according to an example embodiment. FIG. 1B is a schematic equivalent circuit of the battery module of FIG. 1A.

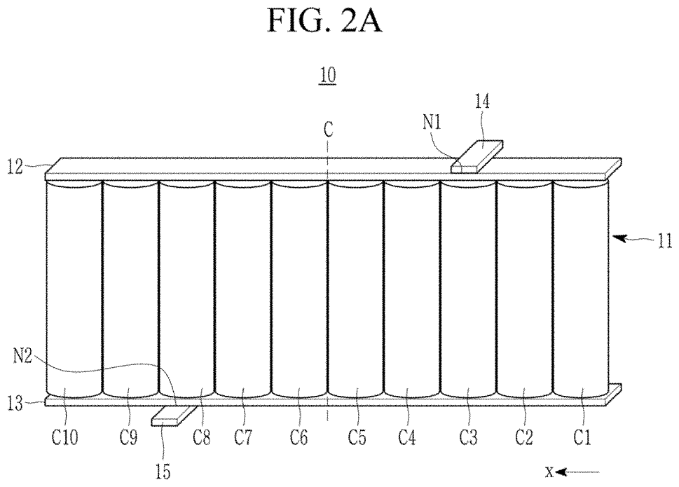

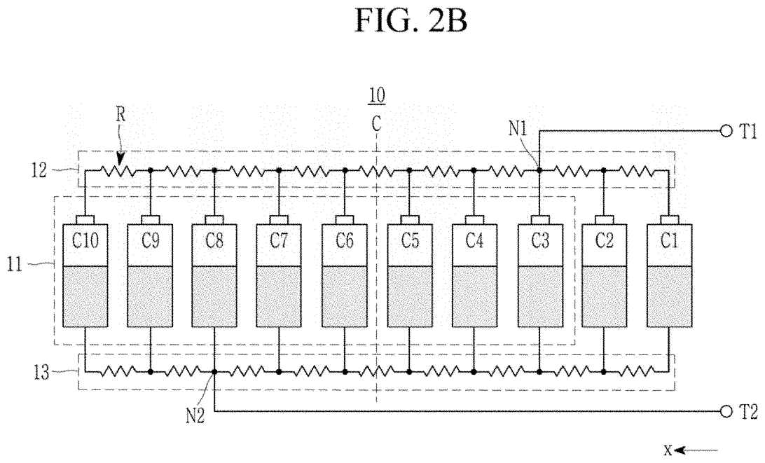

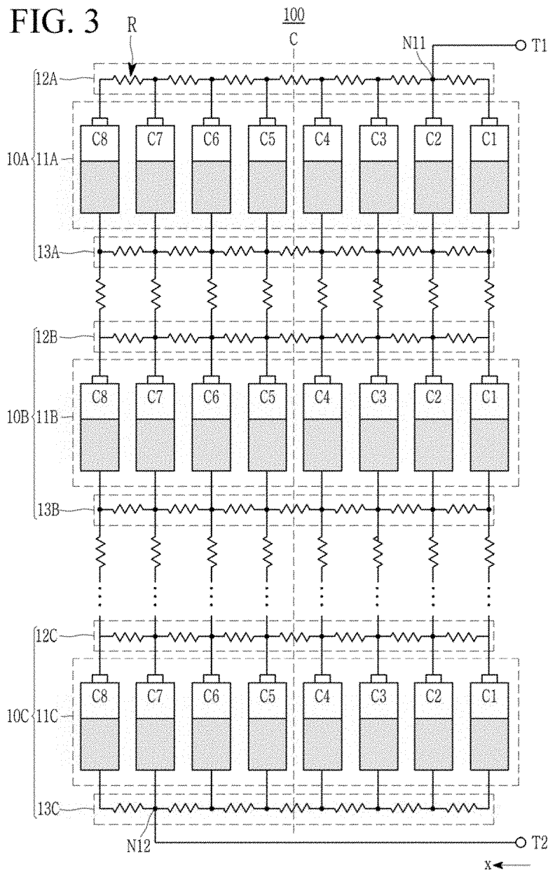

Referring to FIGS. 1A and 1B, a battery module 10 according to an example embodiment may include a first module terminal T1, a second module terminal T2, a battery cell stack 11, a first connection member 12, and a second connection member 13. In FIG. 1B, the first and second connection members 12 and 13 are illustrated as being composed of a plurality of resistance components R connected in series, respectively. In FIG. 1B, each resistance component R corresponds to a portion connecting any two nodes in the first connection member 12 or the second connection member 13. Further, also in FIGS. 2B and 3 to be described later, the first and second connection members are composed of a plurality of resistance components R connected in series, respectively, and each resistance component R corresponds to a portion connecting any two nodes in the first connection member or the second connection member.

The first and second module terminals T1 and T2 may be coupled to an external device (e.g., a charging device or load) to receive current applied from the external device to the battery module 10, or transfer current output from the battery module 10 to the external device.

The battery cell stack 11 may include a plurality of battery cells C1 to C8 arranged in a predetermined direction (x direction).

In FIG. 1A, for convenience of description, a case where the battery cell stack 11 includes 8 battery cells is illustrated as an example, but the number of battery cells included in the battery cell stack 11 may be more than 8 or less than 8.

The first connection member 12 may extend to be sequentially coupled to anode terminals of the plurality of battery cells C1 to C8, to electrically connect the anode terminals of the plurality of battery cells C1 to C8 to each other. The second connection member 13 may extend to be sequentially coupled to cathode terminals of the plurality of battery cells C1 to C8, to electrically connect the cathode terminals of the plurality of battery cells C1 to C8 to each other. As a result, the plurality of battery cells C1 to C8 may be connected between the first connection member 12 and the second connection member 13 in parallel. As described above, in FIG. 1B, a portion connecting the anode terminals or the cathode terminals of adjacent two battery cells in the first connection member 12 or the second connection member 13 is illustrated as one resistance component R.

The first and second connection members 12 and 13 may each be configured by conductive conductors such as a bus bar, etc.

The first connection member 12 may include a first common node N1 to which the first module terminal T1 is coupled. The second connection member 13 may include a second common node N2 to which the second module terminal T2 is coupled. Therefore, current may flow between the first and second connection members 12 and 13, and the first and second module terminals T1 and T2 may be connected to or equivalent to the first and second common nodes N1 and N2.

The first common node N1 may be located in the first connection member 12 at a position between the battery cell C1 (which is located at an outermost side of the battery cell stack 11) and a center C of the battery cell stack 11.

The second common node N2 may be located in the second connection member 13 at a position between the battery cell C8 (which is located at an opposite outermost side of the battery cell stack 11) and the center C of the battery cell stack 11.

Thus, the first and second common nodes N1 and N2 may be located more inward than the outermost battery cells C1 and C8, and located more outward than the center C of the battery cell stack 11.

The first and second common nodes N1 and N2 may be located symmetric to each other based on the center C of the battery cell stack 11, i.e., in opposite directions to each other.

For example, referring to FIGS. 1A and 1B, the first common node N1 may be located closest to an n/4-th battery cell C2 in an array order of a first direction (x direction in FIG. 1A), among the battery cells C1 to C8 constituting the battery cell stack 11. Here, n represents the total number of battery cells constituting the battery cell stack 11.

Correspondingly, the second common node N2 may be located closest to an n/4-th battery cell C7 in an array order of a second direction (i.e., in an opposite direction to the x direction in FIG. 1A) (i.e., 3n/4-th in the array order of the first direction) among the battery cells C1 to C8 constituting the battery cell stack 11.

Herein, the first and second common nodes N1 and N2 being located closest to a specific battery cell may mean being located at a point contacting the battery cell in each connection member or being located closer to the battery cell than other battery cells in each connection member.

Referring to FIG. 1A, the battery module 10 may further include a first common terminal 14 for electrically connecting the first connection member 12 to the first module terminal T1, and a second common terminal 15 for electrically connecting the second connection member 13 to the second module terminal T2. The first and second common terminals 14 and 15 may be physically coupled to the first and second common nodes N1 and N2 of the first and second connection members 12 and 13 by using a coupling scheme such as welding, screw coupling, etc. The first and second common terminals 14 and 15 may also be configured integrally with the first and second connection members 12 and 13. The first and second common terminals 14 and 15 may be connected to the first and second module terminals T1 and T2 through a wire, a bus bar, etc. When the first and second module terminals T1 and T2 are directly coupled to the first and second connection members 12 and 13, the first and second common terminals 14 and 15 may be omitted.

Referring to FIGS. 2A and 2B, the number of battery cells included in the battery cell stack 11 may be a number that is not a multiple of 4. In this case, as an example, the first common node N1 may be located closest to an a-th battery cell that is an integer closest to n/4 in the array order of the first direction among the battery cells constituting the battery cell stack 11. Further, the second common node N2 may be located closest to a b-th battery cell that is the integer closest to n/4 in the array order of the second direction (the opposite direction to the first direction) among the battery cells constituting the battery cell stack 11. Here, a and b may be the same number.

Further, the first common node N1 may be located between c-th and d-th battery cells, which are two integers closest to (e.g., bounding) n/4 in the array order of the first direction among the battery cells constituting the battery cell stack 11. Further, the second common node N2 may be located between e-th and f-th battery cells, which are two integers closest to (e.g., bounding) n/4 in the array order of the second direction among the battery cells constituting the battery cell stack 11. Here, c and e may be the same number, and d and f may be the same number.

Referring to FIGS. 2A and 2B as an example, if the number of battery cells is 10 in the battery cell stack 11, then n/4 becomes 2.5. As a result, referring to FIGS. 2A and 2B, the first and second common nodes N1 and N2 may be located at positions corresponding to a third battery cell C3 in the first direction (x direction) and a third battery cell C8 in the second direction (the opposite direction to the x direction).

In FIGS. 1A to 2B, a case where the battery module is configured only in a parallel structure is illustrated as an example, but the battery module may also be configured in a serial/parallel structure which is a form in which serial coupling and parallel coupling of the battery cells are mixed according to a desired output specification.

FIG. 3 illustrates a schematic equivalent circuit of a battery module according to another example embodiment.

FIG. 3 illustrates one example of a battery module of a serial/parallel structure.

Referring to FIG. 3, the battery module 100 may include a plurality of battery sub-modules 10A, 10B, and 10C, which are electrically connected to each other in series, and module terminals T1 and T2.

The first and second module terminals T1 and T2 may be coupled to an external device (e.g., a charging device or load) to receive current applied from the external device to the battery module 100, or transfer current output from the battery module 100 to the external device.

The battery sub-modules 10A, 10B, and 10C may include respective battery cell stacks 11A, 11B, and 11C, respective first connection members 12A, 12B, and 12C, and respective second connection members 13A, 13B, and 13C.

The battery sub-module 10A connected closest to the first module terminal T1 among the battery sub-modules 10A to 10C, as a highest battery sub-module, may have a highest potential among the battery sub-modules 10A to 10C.

The battery sub-module 10C connected closest to the second module terminal T2 among the battery sub-modules 10A to 10C, as a lowest battery sub-module, may have a lowest potential among the battery sub-modules 10A to 10C.

Each of the battery cell stacks 11A, 11B, and 11C may include a plurality of battery cells C1 to C8 arranged in a predetermined direction (x direction).

In FIG. 3, for convenience of description, a case where the battery cell stacks 11A, 11B, and 11C each include 8 battery cells is illustrated as an example, but the number of battery cells included in the battery cell stacks 11A, 11B, and 11C may be more than 8 or less than 8.

Each of the first connection members 12A, 12B, and 12C may extend to be sequentially coupled to anode terminals of a plurality of battery cells included in corresponding battery sub-modules 10A, 10B, and 10C, to electrically connect the anode terminals of the plurality of battery cells to each other. Each of the second connection members 13A, 13B, and 13C may extend to be sequentially coupled to cathode terminals of the plurality of battery cells included in corresponding battery sub-modules 10A, 10B, and 10C, to electrically connect the cathode terminals of the plurality of battery cells to each other. As a result, the plurality of battery cells included in the battery sub-modules 10A, 10B, and 10C may be connected between corresponding first connection members 12A, 12B, and 12C and second connection members 13A, 13B, and 13C, respectively in parallel.

The first and second connection members 12A, 12B, 12C, 13A, 13B, and 13C may be configured by the conductive conductors such as the bus bar, etc.

The first connection member 12A of the highest battery sub-module 10A (having the highest potential among the battery sub-modules 10A to 10C) may include a first common node N11 to which the first module terminal T1 is coupled. The second connection member 13C of the lowest battery sub-module 10C (having the lowest potential among the battery sub-modules 10A to 10C) may include a second common node N12 to which the second module terminal T2 is coupled. Therefore, current may flow between the battery sub-modules 10A, 10B, and 10C, and the first and second module terminals T1 and T2 may be connected to or equivalent to the first common node N11 (at which the first connection member 12A of the highest battery sub-module 10A is located) and the second common node N12 (at which the second connection member 13C of the lowest battery sub-module 10C is located).

The first common node N11 may be located between the battery cell C1 (which is located at an outermost side of the battery cell stack 11A) and a center C of the battery module 100 in the first connection member 12A of the highest battery sub-module 10A. The second common node N12 may be located between the battery cell C8 (which is located at an outermost side of the battery cell stack 11C) and the center C of the battery module 100 in the second connection member 13C of the lowest battery sub-module 10C. The first common node N11 may be located more inward than the outermost battery cell C1 of the battery cell stack 11A, and located more outward than the center C of the battery cell stack 11A. The second common node N12 may be located more inward than the outermost battery cell C8 of the battery cell stack 11C, and located more outward than the center C of the battery cell stack 11C.

The first and second common nodes N11 and N12 may be located symmetric to each other based on the center C of the battery module 100, i.e., in opposite directions to each other.

For example, referring to FIG. 3, the first common node N11 may be located closest to an n/4-th battery cell C2 in the array order of the first direction (x direction in FIG. 3) among the battery cells C1 to C8 constituting the battery cell stack 11A in the first connection member 12A of the highest battery sub-module 10A. Further, the second common node N12 may be located closest to an n/4-th battery cell C7 in the array order of the second direction (the opposite direction to the x direction in FIG. 3) among the battery cells C1 to C8 constituting the battery cell stack 11C in the second connection member 13C of the lowest battery sub-module 10C. Here, n represents the total number of battery cells constituting the corresponding battery cell stack.

The battery module 100 may further include a first common terminal (not illustrated in FIG. 3; see reference numeral 14 in FIG. 1A) for electrically connecting the first connection member 12A of the highest battery sub-module 10A to the first module terminal T1, and a second common terminal (not illustrated in FIG. 3; see reference numeral 15 in FIG. 1A) for electrically connecting the second connection member 13C of the lowest battery sub-module 10C to the second module terminal T2. The first and second common terminals may be physically coupled to the first and second common nodes N11 and N12 by using the coupling scheme such as welding, screw coupling, etc. The first and second common terminals may also be configured integrally with the first connection member 12A of the highest battery sub-module 10A and the second connection member 13C of the battery sub-module 10C, respectively. The first and second common terminals may be connected to the first and second module terminals T1 and T2 through the wire, the bus bar, etc. When the first and second module terminals T1 and T2 are directly coupled to the first connection member 12A of the highest battery sub-module 10A and the second connection member 13C of the battery sub-module 10C, the first and second common terminals may be omitted.

Although not shown in FIG. 3, the number of battery cells included in each of the battery cell stacks 11A, 11B, and 11C of the battery sub-modules 10A, 10B, and 10C may not be a multiple of 4. In this case, as an example, the first common node N11 may be located closest to an a-th battery cell which is an integer closest to n/4 in the array order of the first direction among the battery cells constituting the battery cell stack of the highest battery sub-module. Further, the second common node N12 may be located closest to a b-th battery cell which is the integer closest to n/4 in the array order of the second direction (the opposite direction to the first direction) among the battery cells constituting the battery cell stack of the lowest battery sub-module. Here, a and b may be the same number. Further, as another example, the first common node N11 may be located between c-th and d-th battery cells, which are two integers closest to n/4 in the array order of the first direction among the battery cells constituting the battery cell stack of the highest battery sub-module. Further, the second common node N2 may be located between e-th and f-th battery cells, which are two integers closest to n/4 in the array order of the second direction among the battery cells constituting the battery cell stack of the lowest battery sub-module. Here, c and e may be the same number, and d and f may be the same number.

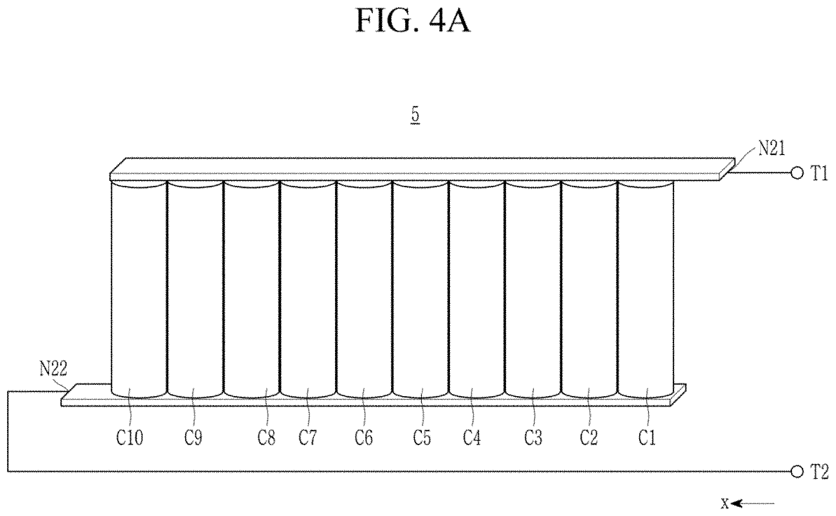

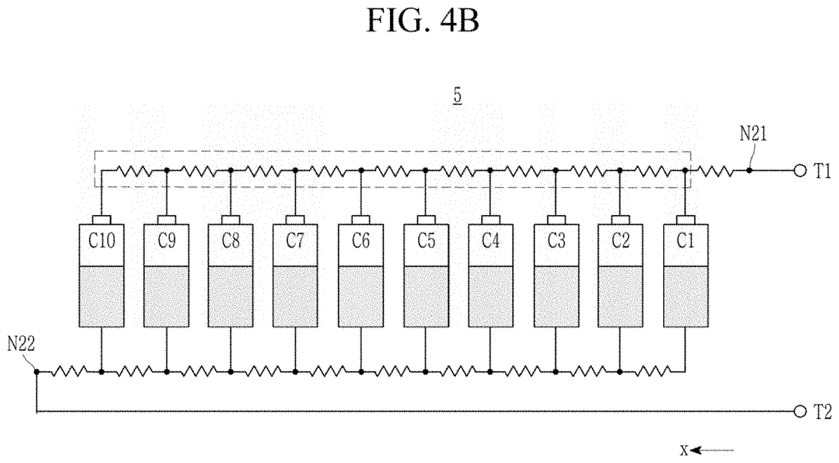

FIGS. 4A and 4B illustrate an example of a comparative battery module.

Referring to FIGS. 4A and 4B, first and second common nodes N21 and N22, to which the first and second module terminals T1 and T2 are coupled in the comparative battery module 5 in the comparative battery module, may be located closest to the battery cells C1 and C10, respectively, which are located at the outermost side among the battery cells C1 to C10.

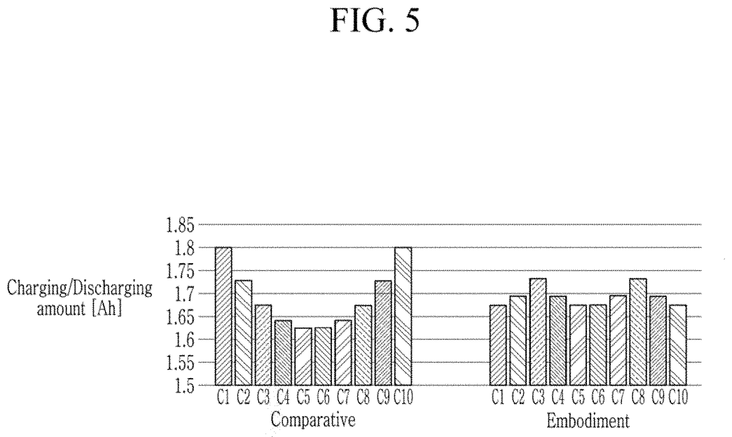

FIG. 5 is used for describing the effect of an example embodiment.

FIG. 5 illustrates results of simulating charging/discharging amounts of a comparative battery module and a battery module according to an example embodiment.

In FIG. 5, the comparative battery module represents the comparative battery module 5 illustrated in FIGS. 4A and 4B, and the example embodiment represents the battery module 10 illustrated in FIGS. 2A and 2B.

Table 1 below tabulates the data of FIG. 5. In Table 1, the column (max-min) represents a value acquired by subtracting a charging/discharging amount (min) of a battery cell having a smallest charging/discharge amount from a charging/discharging amount (max) of a battery cell having a largest charging/discharging amount, and a represents a ratio of a value of (max-min) to an average charging/discharging amount of the battery cells C1 to C10 as a percentage.

TABLE 1

| | | | | | | | | | | | | α |
|---|---|---|---|---|---|---|---|---|---|---|---|---|
| | C1 | C2 | C3 | C4 | C5 | C6 | C7 | C8 | C9 | C10 | (Max − min) | (%) |
| Comparative | 1.804 | 1.73 | 1.677 | 1.643 | 1.626 | 1.626 | 1.643 | 1.677 | 1.73 | 1.804 | 0.18 | 10.50 |
| Example | 1.677 | 1.695 | 1.732 | 1.695 | 1.677 | 1.677 | 1.695 | 1.732 | 1.695 | 1.677 | 0.055 | 3.26 |
| embodiment | | | | | | | | | | | | |

Referring to FIG. 5, when the respective battery modules are charged/discharged by using the same charging/discharging current, it can be seen that a current deviation between the battery cells of the battery module according to the example embodiment is smaller than the current deviation of the comparative battery module.

The example embodiment reduces the current deviation between the battery cells, to thus increase maximum allowable current of the battery module. Further, a temperature deviation between the battery cells due to the current deviation, and a lifespan deviation between the battery cells due to current and temperature deviations, may also be reduced.

An electronic or electrical device according to example embodiments described herein and/or any other related device or component may be implemented using any suitable hardware, firmware (for example, application-specific integrated circuit), software, or a combination of software, firmware, and hardware. For example, various components of the device may be formed on one integrated circuit (IC) chip or an individual IC chip. Further, various components of the device may be implemented on a flexible printed circuit film, a tape carrier package (TCP), a printed circuit board (PCB), or one substrate. An electrical connection or interconnection described in the present specification may be implemented by wiring lines or conductive elements on a PCB or another part of a circuit carrier. The conductive element may include a metallization such as surface metallizations and/or pins and may include conductive polymers or ceramics. Further, the electrical energy may be transmitted by means of wireless connection using electromagnetic emission or light.

Further, various components of this device may be processes or threads which are executed on one or more processors, executed in one or more computing devices, execute a computer program instruction, and interact with the other system components so as to perform various functions described herein. The computer program instruction is stored in a memory which can be implemented in a computing device using a standard memory device such as a random access memory (RAM). The computer program instruction may also be stored in a non-transitory computer readable medium such as a CD-ROM or a flash drive.

As described above, example embodiments may provide a battery module configured to minimize a current deviation between battery cells.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SYMBOLS

10, 100: Battery module

10A - 10C: Battery sub-module

11, 11A, 11B, 11C: Battery cell stack

12, 12A, 12B, 12C: First connection member

13, 13A, 13B, 13C: Second connection member

14: First common terminal

15: Second common terminal

N1, N11: First common node

N2, N12: Second common node

C1-C10: Battery cell

T1: First module terminal

T2: Second module terminal

What is claimed is:

1. A battery module, comprising:
first and second module terminals configured to be connected to an external device;
a battery cell stack including a plurality of battery cells;
a first connection member coupled to anode terminals of the plurality of battery cells; and
a second connection member coupled to cathode terminals of the plurality of battery cells, wherein:
the plurality of battery cells includes a first battery cell at a first outermost side of the battery cell stack, and a second battery cell at an opposite outermost side of the battery cell stack,
the first connection member includes a first common node to which the first module terminal is coupled,
the second connection member includes a second common node to which the second module terminal is coupled,
the first common node is located in the first connection member at a position between a center of the battery cell stack and the first battery cell, and
the second common node is located in the second connection member between the second battery cell and the center of the battery cell stack.

2. The battery module as claimed in claim 1, wherein the first common node and the second common node are located symmetric to each other based on the center of the battery cell stack.

3. The battery module as claimed in claim 1, wherein:
the first common node is located closest to a third battery cell located at an n/4-th position in an array order of a first direction among the plurality of battery cells,
the second common node is located closest to a fourth battery cell located at an n/4-th position in the array order of a second direction, which is opposite to the first direction, among the plurality of battery cells, and
n is a total number of battery cells in the battery cell stack.

4. The battery module as claimed in claim 1, wherein:
the first common node is located closest to a third battery cell located at an a-th position in an array order of a first direction among the plurality of battery cells,
the second common node is located closest to a fourth battery cell located at a b-th position in the array order of a second direction, which is opposite to the first direction, among the plurality of battery cells,
a and b are integers closest to n/4, and
n is a total number of battery cells in the battery cell stack.

5. The battery module as claimed in claim 1, wherein:
the first common node is located between third and fourth battery cells located at c-th and d-th positions in an array order of a first direction among the plurality of battery cells,
the second common node is located between fifth and sixth battery cells located at e-th and f-th positions in the array order of a second direction, which is opposite to the first direction, among the plurality of battery cells,
c and e are the same number, and are one of two integers that are closest to n/4,
d and f are the same number, and are the other one of the two integers that are closest to n/4, and
n is a total number of battery cells in the battery cell stack.

6. The battery module as claimed in claim 1, wherein:
at least one battery cell is located between the first battery cell and the first common node, and
at least one battery cell is located between the second battery cell and the second common node.

7. The battery module as claimed in claim 6, wherein a total number of battery cells located between the first battery cell and the first common node and a total number of battery cells located between the second battery cell and the second common node are the same as each other.

8. The battery module as claimed in claim 1, further comprising:
a first common terminal for coupling the first connection member to the first module terminal; and
a second common terminal for coupling the second connection member to the second module terminal.

9. A battery module, comprising:
first and second module terminals configured to be connected to an external device; and
a plurality of battery sub-modules, wherein:
each of the plurality of battery sub-modules includes:
a battery cell stack including a plurality of battery cells,
a first connection member coupled to anode terminals of the plurality of battery cells, and
a second connection member coupled to cathode terminals of the plurality of battery cells,
the first connection member of a first battery sub-module having a highest potential among the plurality of battery sub-modules includes a first common node to which the first module terminal is coupled,
the second connection member of a second battery sub-module having a lowest potential among the plurality of battery sub-modules includes a second common node to which the second module terminal is coupled,
the first common node is located in the first connection member of the first battery sub-module at a position between a first battery cell, among two battery cells respectively located at outermost sides of the first battery sub-module, and a center of the battery module, and
the second common node is located in the second connection member of the second battery sub-module at a position between a second battery cell, located in an opposite direction to the first battery cell, among two battery cells respectively located at outermost sides of the second battery sub-module, and the center of the battery module.

10. The battery module as claimed in claim 9, wherein the first common node and the second common node are located symmetric to each other based on the center of the battery module.

11. The battery module as claimed in claim 9, wherein:
the first common node is located closest to a third battery cell located at an n/4-th position in an array order of a first direction among the plurality of battery cells of the first battery sub-module, n being a total number of battery cells of the first battery sub-module, and
the second common node is located closest to a fourth battery cell located at an n/4-th position in the array order of a second direction, which is opposite to the first direction, among the plurality of battery cells of the second battery sub-module, n being a total number of battery cells of the second battery sub-module.

12. The battery module as claimed in claim 9, wherein:
the first common node is located closest to a third battery cell located at an a-th position in an array order of a first direction among the plurality of battery cells of the first battery sub-module, n being a total number of battery cells of the first battery sub-module, and a being an integer closest to n/4, and
the second common node is located closest to a fourth battery cell located at a b-th position in the array order of a second direction, which is opposite to the first direction, among the plurality of battery cells of the second battery sub-module, n being a total number of battery cells of the second battery sub-module, and b being an integer closest to n/4.

13. The battery module as claimed in claim 9, wherein:
the first common node is located between third and fourth battery cells located at c-th and d-th positions in an array order of a first direction among the plurality of battery cells of the first battery sub-module, n is a total number of battery cells of the first battery sub-module, c is one of two integers that are closest to n/4, and d is the other one of the two integers that are closest to n/4, and
the second common node is located between fifth and sixth battery cells located at e-th and f-th positions in the array order of a second direction, which is opposite to the first direction, among the plurality of battery cells of the second battery sub-module, n is a total number of battery cells of the second battery sub-module, e is one of two integers that are closest to n/4, and f is the other one of the two integers that are closest to n/4.

14. The battery module as claimed in claim 9, wherein:
at least one battery cell is located between the first battery cell and the first common node, and
at least one battery cell is located between the second battery cell and the second common node.

15. The battery module as claimed in claim 14, wherein a total number of battery cells located between the first battery cell and the first common node and a total number of battery cells located between the second battery cell and the second common node are the same as each other.

16. The battery module as claimed in claim 9, further comprising:
a first common terminal for coupling the first connection member of the first battery sub-module to the first module terminal; and
a second common terminal for coupling the second connection member of the second battery sub-module to the second module terminal.
